(19) United States
(12) Patent Application Publication
(10) Pub. No.: US 2003/0012387 A1
(43) Pub. Date: Jan. 16, 2003

(54) Communication method with encryption key escrow and recovery

(76) Inventors: Henri Gilbert, Bures nu Yolle (FR); David Arditti, Clamart (FR); Thierry Baritaud, Vanves (FR); Pascal Chauvaud, Issy Les Moulineaux (FR)

Correspondence Address: PEARNE & GORDON LLP, 526 SUPERIOR AVENUE EAST, SUITE 1200, CLEVELAND, OH, 44114-1484, US

(21) Appl. No.: 10/181,598

(22) PCT Filed: Jan. 30, 2001
(86) PCT No.: PCT/FR01/00285

(30) Foreign Application Priority Data
Jan. 31, 2000 (FR) 00/01185

(51) Int. Cl. H04L 9/00

(52) U.S. Cl. 380/286

(57) ABSTRACT

Communication process with key encryption escrow and recovery systems.

The entity participating in a communication session generates a session key (SK) through a pseudorandom generator that is initiated by the entity's secret key and an initial value (IV). The session key codes the message. The escrow authority that files the secret code may recover the message and the initial value (IV).

Application to secure communication systems.

### TECHNICAL FIELD

The object of the present invention is a communication process, which allows for key encryption escrow and recovery operations. These operations guarantee one or several previously determined bodies (for example, a security administrator of a company network, a trusted third party, and in certain cases, actual users of an encryption system) the possibility to recover, if need be, the session key used during communication on the basis of exchanged data. The possibility to recover a session key may arise from a requirement to legally intercept or recover keys within a company.

The invention has an application in secure communication services.

### STATE OF THE PRIOR ART

There are essentially two types of key escrow/recovery techniques that guarantee one or several escrow authorities the ability to rebuild, from data exchanged during communication between two speakers or entities a and b, the session key used in order to decode this communication. These two types of techniques may be implemented without any data exchange occurring during each communication between the entities and the escrow authority or authorities (process known as “off line”).

Type 1: Filing of static keys to distribute keys with an escrow authority.

This type of technique is applied to systems where a session key established between speakers uses a key exchange protocol that relies on ownership by one of the speakers (for example, b) of a secret static key (in other words, that is not renewed at each session). The secret key used by b in the key exchange protocol is filed with an escrow authority (or distributed amongst several escrow authorities). Ownership of this secret allows the escrow authority (or authorities) to rebuild, if necessary, every key session exchanged between a and b from messages used in the protocol to establish this key. An example of this key escrow and recovery method is offered in the article “A Proposed Architecture for Trusted Third Party Services” by N. Jefferies, C. Mitchell and M. Walker, that appeared in “Lecture Notes in Computer Science 1029, Cryptography Policy and Algorithms Conference”, pp. 98-104, Springer Verlag, 1996. It is one of the principal methods within this first type of techniques, which is currently being considered in Europe.

Type 2: Recovery of dynamic encryption keys (session keys) through legal fields.

As opposed to the previous technique, this second type of technique does not require prior filing of the secret static keys used during the exchange of session keys, but rather the insertion of one or several legal fields within the messages exchanged between a and b during a secure communication, containing information on the session key SK in a format intelligible only to the escrow authority. The session key SK (or information on this key) may, for example, be coded using the RSA public key of an escrow authority. The “Secure Key Recovery” (SKR) protocol, suggested by IBM, is included in this type of techniques.

These two types of techniques present certain drawbacks for the protection of open applications that may wish to be used between speakers in different countries or separate jurisdictions, as for example with secure electronic mail systems. When a secure application is likely to be used for international communication, the following two conditions should be fulfilled:

(i) For all relevant communications, each country must be free to implement, or not, a key escrow/recovery system for this application.

(ii) For each country with a key escrow/recovery system in place, authorities entitled to recover, if necessary, session keys for coding an international communication, need to be able to do so without having to cooperate with authorities in other countries for each interception.

Thus, the aforementioned known techniques do not fulfil, if only partly, the following conditions:

For processes of the first type, when the distribution method of the relevant session key comes from the public key encryption (in particular the RSA encryption used here in a large amount of security products), recovery of the session key in a communication is only possible, without international cooperation in the country where the secret key used for key distribution was filed. This problem has led certain authors (cf. the aforementioned N. Jefferies et al article) to advocate key escrow/recovery systems that rely on a more symmetrical key exchange method similar to the Diffie-Hellman outline. These systems fulfil the previous condition (ii) and could possibly, on the basis of certain adaptations, fulfil condition (i) yet they present strong constraints on the key distribution method used that notably excludes the use of the RSA algorithm.

For processes of the second type, key recovery in the country of destination using legal fields relies on the transmitting country establishing a key escrow/recovery technique that is adapted to the country of destination, namely the transmission of legal fields intelligible to the escrow authorities of the country of destination. This constraint contradicts the previous condition (i).

The D. E. Denning article “Descriptions of Key Escrow Systems” published in “Communications of the ACM”, vol. 39, n°3, March 1996 and the D. E Denning and D. K. Branstad article “A Taxonomy of Key Recovery Encryption Systems” published in “Communications of the ACM”, vol. 39, n°3, March 1996 both provide a description and a comparative analysis of more than thirty key escrow and recovery systems.

We may limit ourselves to two examples illustrated in the attached FIGS. 1 and 2.

Firstly, FIG. 1 shows two entities a, b each fitted with cryptography means (not shown) and each equipped with an identity Idₐ, Id_{b}, with a public key and a secret encryption key respectively Pₐ, P_{b} and Sₐ, S_{b}, as well as a certificate Cₐ, C_{b}. Further, two escrow authorities Tₐ and T_{b} related to two entities a and b, where these two authorities each file secret keys Sₐ, S_{b} of the relevant entities and their certificates Cₐ or C_{b}. The certificates attest to the relation between the secret key and the public key, and the correct filing of the secret key. The certification authority is not shown on this figure. The certificate may conform to recommendation X509 of the UIT-T.

The communication process between these different means includes the following operations:

A) Entity a that engages in a transmission session of a message M:

ChecSK the validity of certificates Cₐ and C_{b}.

Produces a session key SK to implement a pseudo-random generator (not shown).

Uses its cryptography facilities to code the session key SK with the public key P_{b} of the other entity and codes message M with the session key according to a symmetric encryption algorithm.

Transmits its identity IDₐ or its certificate Cₐ, the encrypted session key P_{b}(SK) and the coded message E_{SK}(M)

B) Entity b, that receives the transmission:

ChecSK the validity of certificates Cₐ and C_{b}.

Recovers session key SK by using its secret key S_{b}.

Decodes message M by using the session key SK.

With such a process, the escrow authority T_{b} may, if desired, also recover the session key SK with the aid of the secret key S_{b} which it filed and may thus also recover the transmitted message.

This process presents a drawback, namely, if the escrow authority T_{b} may recover the session key SK (since it filed the secret key T_{b}) and therefore the transmitted message, the case is different for escrow authority Tₐ since it does not have the secret key S_{b}. Cooperation between escrow authorities Tₐ and T_{b} must therefore be accounted for which is rare in the case of international communication.

This difficulty comes especially from the fact that the key exchange process resorts to an unsymmetrical encryption-decryption system that uses a pair of keys, respectively public-secret, as for example with RSA encryption. Certain authors advocate more symmetrical processes similar to a protocol known as Diffie-Hellman. This process is illustrated in FIG. 2. The means found here are noticeably similar to those in FIG. 1, namely two entities a and b, and two escrow authorities Tₐ and T_{b}. Parameters of the Diffie-Hellman protocol consist of a large prime number p, known as a module, and a generator number g. The two escrow authorities Tₐ and T_{b} are associated with these numbers p and g. The secret key Sₐ for a is a secret exponent * which is filed in Tₐ and the public key for a is Pₐ=g*. Certificate Cₐ contains the public key Pₐ=g*. The same applies to entity b, namely (S_{b}=β, P_{b}=g^{β}).

In order to send a message to entity b, entity a generates a session key SK and addresses b with the following:

Its certificate Cₐ (which contains Pa=g*).

The session key coded with an algorithm E using key g*^{β} (Eg*^{β} (SK)).

The message coded by the session key SK (E_{SK}(M))

Knowledge by Tₐ of * and the public key P_{b}=g^{β} of b allows Tₐ to calculate (g^{β})=g^{β}*. This also applies to T_{b} which can calculate (g*)^{β}=g^{β}*. Thus, g*^{β} is shared by a and b.

Each authority Tₐ and T_{b} may therefore recover the session key (SK) and similarly the message (M).

But, here again, the outline calls for an agreement between both parties.

The aim of the present invention is to remedy these drawbacks by suggesting a process which does not require any agreement between communicating parties, where the recovery of the session key and the message may be done by using only the data exchanged in the communication.

### DESCRIPTION OF THE INVENTION

Precisely, the object of the invention is a communication process coded with key encryption escrow and recovery systems, by implementing:

A first entity (a) consisting of the first cryptography means (MCₐ) and equipped with a first identity (Idₐ), a first public key for key distribution (Pₐ) and a first secret key for key distribution (Sₐ) that corresponds to said first public key (Pₐ)

A second entity (b) consisting of the second cryptography means (MC_{b}) and equipped with a second identity (Id_{b}), a second public key for key distribution (P_{b}) and a second secret key for key distribution (S_{b}) that corresponds to said second public key (P_{b}).

In that this process consists of:

(i) A preliminary phase to establish a session key (SK) phase in which at least one of the entities (a, b) produces a session key (SK) and forms a cryptogram consisting of this key coded by the public key (P_{b}, Pₐ) of the other entity, where the other entity (b, a) decodes said cryptogram with the aid of its secret key (S_{b}, Sₐ) and recovers the session key (SK).

(ii) An exchange of messages (M) phase in which the entities (a, b) form cryptograms ESK(M) consisting of messages (M) coded by the session key (SK) that is established in the preliminary phase, where each entity decodes the received cryptogram with the aid of the session key (SK) and thus recovers the message it has been sent.

This process is characterised in that:

It further implements at least one escrow authority (Tₐ, T_{b}) associated with one of the entities (a, b), where this authority files the secret key (Sₐ, S_{b}) of the related entity (a, b).

In the preliminary phase, the entity (a, b) that produces the session key (SK) implements a pseudorandom generator (PRGₐ, PRG_{b}) known by the related escrow authority (Tₐ, T_{b}) and initiates this pseudorandom generator with the aid of its secret key (Sₐ, S_{b}) and an initial value (IV) deduced from relevant data by an algorithm known by the escrow authority (Tₐ, T_{b}).

According to an application mode, the escrow authority (Tₐ, T_{b}) associated with the entity (a, b) that produces the session key (SK) in the preliminary phase, implements a pseudo-random generator identical to that of the related entity (PRGₐ, PRG_{b}), initiates this generator with said initial value (IV) and the secret key (Sₐ, S_{b}) of the related entity (a, b) that it filed, and thus recovers the session key (SK).

According to another application mode, the escrow authority (T_{b}, Tₐ) associated with the entity (b, a) that has not produced the session key (SK) in the preliminary phase, decodes the cryptogram of the session key (P_{b}(SK), Pₐ(SK)) with the aid of the secret key (S_{b}, Sₐ) of the related entity (b, a) that it filed, and thus recovers the session key (SK).

The initial value (IV) may either be deduced from data exchanged between entities a and b in the preliminary phase to establish the session key, or obtained from successive trials using data capable of generating a given number of values, where this number is sufficiently limited for the time taken by the escrow authority to be compatible with the considered application.

As explained in the introduction, the escrow authority may be an authorised third party, or a security administrator of a company network, or even the actual user (the escrow is therefore a “selfescrow”).

### BRIEF DESCRIPTION OF DRAWINGS

FIG. 1, already described, illustrates a process known as asymmetric.

FIG. 2, already described, illustrates a process known as symmetric.

FIG. 3 illustrates in a diagram a process according to the invention.

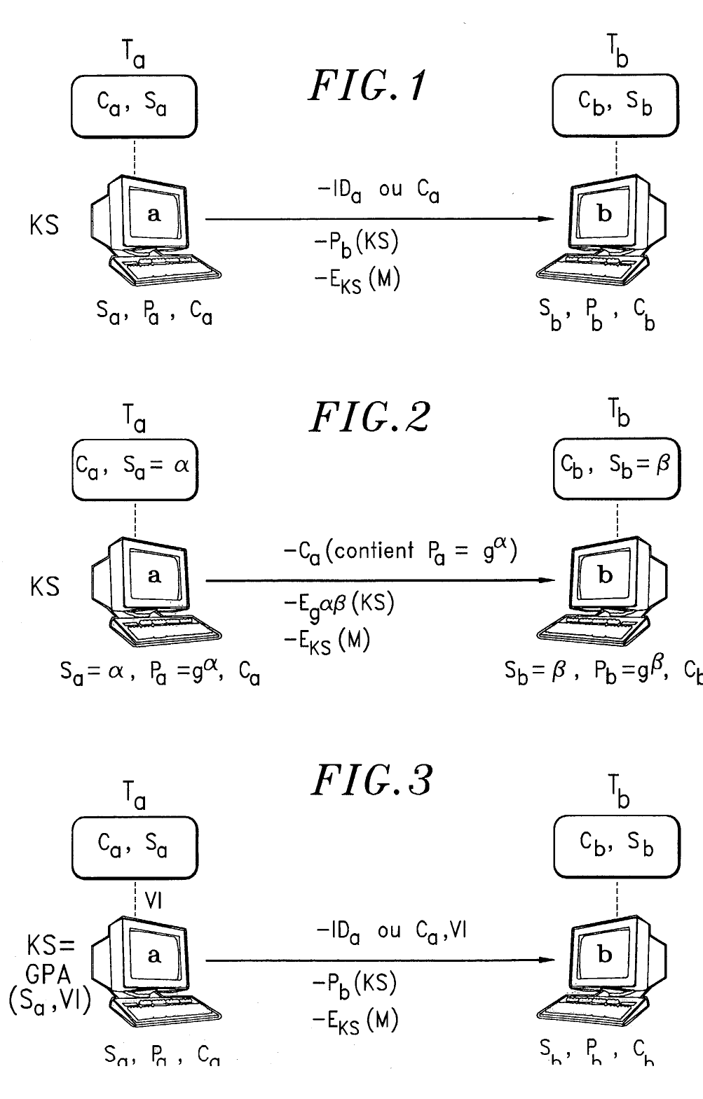

### DESCRIPTION OF PARTICULAR APPLICATION MODES

The invention process may be described by first specifying certain initial conditions, subsequently outlining the procedures developed in the user's cryptology means, and finally describing the procedure of key recovery.

A. Initial Conditions

The secret key Sₐ of the key encryption system with public key used by entity a in order to establish session keys is filed with escrow authority Ta. Delivery of certificate Cₐ, attesting to the relation between identity Idₐ of a and public key Pₐ (for example a certificate that conforms to recommendation X509 of the UIT-T) to a by a certification authority CA designated in advance by Tₐ, must be subject to this filing. Possession by a of a certificate from CA proves that filing with Tₐ of the secret key Sₐ corresponding to public key Pₐ effectively occurred. In practice, the certification authority CA and the third party escrow Ta may be one and the same body, or two separate bodies having signed an agreement. According to circumstances, generating the secret key Sₐ may be done by user a or a third party Tₐ.

B. Procedures in the User's Cryptology Means

“Cryptology means of a”, noted as MCₐ, is understood to be the software and material resources enabling cryptographic calculations to establish a session and encryption key for a during a secure communication. For example, the client software of a secure electronic mail system may be considered a cryptology means.

In order for the user's cryptology method MCₐ to conform to the third party escrow service provided by Tₐ, it must fulfil the following conditions:

(i) Performance of MCₐ encryption functions (to establish a session, encryption key) must be subject to presence of a certificate Cₐ from a certification authority CA designated by Tₐ and the corresponding secret key Sₐ. The encryption method MCₐ must not only check that the certificate Cₐ is valid, but that there is also an effective relation between the secret key Sₐ and the public key Pₐ contained within Tₐ. These checks are necessary to ensure that the third party escrow Tₐ is able to recover the session keys used by MCₐ.

(ii) The process to generate keys implemented by MCₐ, typically the algorithm to generate keys used to generate a session key SK when a initiates a secure session with speaker b, must be a pseudo-random generator PRG known by Tₐ, and whose seeds, namely the entries from which the values of the generators are calculated, consist of:

The secret key Sₐ (or, according to a variant, a function H(Sₐ) of this key.

An initial value IV deduced from variable data by an algorithm known by Tₐ and contained within the non-coded portion of communications between a and its speakers (for example, the date and time), or from a meter controlled from within MCₐ.

The pseudo-random generator must fulfil the following conditions:

(i) The exit value of this generator (typically the session key SK) must be easy to deduce from Sₐ (or H(Sₐ)) and the initial value IV. According to a preferred production mode, the size of the initial value IV may be limited to an effective size between 20 and 40 bits, so that, when the secret key Sₐ is known, recovery of the generator's exit value remains possible through exhaustive research even when the exact value of IV is lost.

(ii) Information on Sₐ (or H(Sₐ)) must be difficult to predict from the set of values of IV and the corresponding exit values of PRG(Sₐ, IV) or PRG(H(Sa), IV).

(iii) Information relating to exits PRG(Sₐ, IV) or PRG(H(Sₐ), IV) for the different values of IV must be difficult to predict when the value Sₐ (or H(Sₐ)) is not known.

C. Procedures of Key Recovery

There are two separate procedures for key recovery of the session key SK used to code a secure communication between user a and receiver b by Tₐ, or an authority entitled to access secret Sₐ filed by Tₐ, which are as follows:

(i) If the session key SK is produced by b and received by a and coded with the aid of public key Pₐ of a, then Tₐ may recover key SK by decoding the cryptogram Pₐ(SK) transmitted in the key distribution protocol with the aid of the filed secret Sₐ.

(ii) If the session key SK is produced with the cryptology method of a and sent to b coded under the public key P_{b} of b, then Tₐ may recover the initialisation value IV from the simple exchanged data between a and b and rebuild the SK value with the aid of IV and the filed value of Sₐ, by the calculation SK=PRG(Sₐ, IV) or SK=PRG(H(Sₐ), IV). In the cases where IV is the meter content or where the effective size of IV is limited or, for whichever reason, IV may not be recovered from the simple data, it is still possible for Tₐ to recover the session key SK through an exhaustive test of possible IV values by checking whether the value SK=PRG(Sₐ, IV) or SK=PRG(H(Sₐ), IV) obtained for each is the right one.

By combining the basic procedures (i) and (ii) defined above, Tₐ is still able to recover the session key in the case where a more complex protocol to establish the session key is used between a and b. By way of example, we may consider the following protocol: b generates a secret value SK1 and transmits it to a coded under the public key Pₐ of a; a generates a secret value SK2 and transmits it to b coded under public key P_{b} of b; a and b calculate the session key SK that is equal OR exclusive to values SK1 and SK2 (SK=K1 XOR K2). With a protocol of this type, Tₐ would be able to recover SK1 by using procedure (i) defined above and recover SK2 by using procedure (ii), and therefore, from these two values, recover SK.

The process that has just been described may be implemented according to variants in which information pertaining to secret key Sₐ is not filed with a sole entity Tₐ, but divided into two “parts” which are filed with separate third party escrow authorities.

For example, the secret key Sₐ of a may consist of a secret RSA exponent d. This secret may be divided into two “parts” d1 and d2 such as d1+d2=d. Two escrow authorities Tₐ and T_{b}, respectively responsible for filing d1 and d2 (and the public module nₐ of a), are able:

To check, without disclosing their part of secret d, that they are effectively capable of calculating the secret function of key Sₐ. In order to do this, each of them must calculate module n, the power of entry value determined by its part, and for the resulting values to be subsequently multiplied amongst them as module nₐ.

To recover a session key SK from data of the protocol to establish this key (by disclosing, if necessary, to the other third party or an interception authority their part of key Sₐ).

1. Communication process coded with encryption key escrow and recovery systems implementing:
A first entity (a) consisting of the first cryptography means (MCₐ) and equipped with a first identity (Idₐ), a first public key for key distribution (Pₐ) and a first secret key for key distribution (Sₐ) that corresponds to said first public key (Pₐ).
A second entity (b) consisting of the second cryptography means (MC_{b}) and equipped with a second identity (Id_{b}), a second public key for key distribution (P_{b}) and a second secret key for key distribution (S_{b}) that corresponds to said second public key (P_{b}).
In that this process consists of:
(iii) A preliminary phase to establish a session key (SK) phase in which at least one of the entities (a, b) produces a session key (SK) and forms a cryptogram consisting of this key coded by the public key (P_{b}, Pₐ) of the other entity, where the other entity (b, a) decodes said cryptogram with the aid of its secret key (S_{b}, Sₐ) and recovers the session key (SK).
(iv) An exchange of messages (M) phase in which the entities (a, b) form cryptograms ESK(M) consisting of messages (M) coded by the session key (SK) that is established in the preliminary phase, where each entity decodes the received cryptogram with the aid of the session key (SK) and thus recovers the message it has been sent.
This process is characterised in that:
It further implements at least one escrow authority (Tₐ, T_{b}) associated with one of the entities (a, b), where this authority files the secret key (Sₐ, S_{b}) of the related entity (a, b).
In the preliminary phase, the entity (a, b) that produces the session key (SK) implements a pseudorandom generator (PRGₐ, PRG_{b}) known by the related escrow authority (Tₐ, T_{b}) and initiates this pseudorandom generator with the aid of its secret key (Sₐ, S_{b}) and an initial value (IV) deduced from relevant data by an algorithm known by the escrow authority (Tₐ, T_{b}).

2. Process in accordance with claim 1 above in which the escrow authority (Tₐ, T_{b}) associated with the entity (a, b) that produces the session key (SK) in the preliminary phase, implements a pseudo-random generator identical to that of the related entity (PRGₐ, PRG_{b}), initiates this generator with said initial value (IV) and the secret key (Sₐ, S_{b}) of the related entity (a, b) that it filed, and thus recovers the session key (SK).

3. Process in accordance with claim 1 above, in which the escrow authority (T_{b}, Tₐ) associated with the entity (b, a) that has not produced the session key (SK) in the preliminary phase, decodes the cryptogram of the session key (P_{b}(SK), Pₐ(SK)) with the aid of the secret key (S_{b}, Sₐ) of the related entity (b, a) that it filed, and thus recovers the session key (SK).

4. Process in accordance with any one of claims 1 to 3 above, in which the initial value (IV) is deduced from data exchanged between the entities (a, b) in the preliminary phase to establish the session key (SK).

5. Process in accordance with claim 2 above, in which the escrow authority obtains the initial value (IV) through exhaustive tests from data that is capable of receiving a limited number of values.

6. Process in accordance with claim 1 above, in which the pseudo-random generator (PRGₐ, PRG_{b}) of an entity (a, b) is initiated by a one-way function (H(Sₐ), H(S_{b})) of the secret key (Sₐ, S_{b}) of this entity (a, b).

7. Process in accordance with claim 1 above, in which at least one first certification authority (CAₐ, Ca_{b}) delivers a certificate (Cₐ, C_{b}) attesting to the relation between the identity (Idₐ, Id_{b}) of the entity and the public key (Pₐ, P_{b}) if and only if the filing of the corresponding secret key (Sₐ, S_{b}) effectively occurred with the corresponding escrow authority (Tₐ, T_{b}), in that the preliminary phase to establish a session key (SK) and the message exchange phase are, in the cryptology means (MCₐ, MC_{b}), both subject to the validity of the certificate (Cₐ, C_{b}) and the effective relation between the public key (Pₐ, P_{b}) contained in this certificate and the secret distribution key (Sₐ, S_{b}).

8. Process in accordance with claim 1 above, in which, for at least one of the entities (a, b), the certification authority (CAₐ, Ca_{b}) and the escrow authority related to this entity (Tₐ, T_{b}) are combined under a single authority.

9. Process in accordance with claim 1 above, in which the escrow authority (Tₐ, T_{b}) is divided into two partial authorities (Tₐ¹,Tₐ²)(T_{b}¹,T_{b}²) each filing a part (Sₐ¹,Sₐ²)(S_{b}¹,S_{b}¹) of the secret distribution key (Sₐ, S_{b}), in that neither of the two partial authorities is capable of rebuilding the secret distribution key (Sₐ, S_{b}) on its own, but in that both partial authorities are capable of rebuilding the secret distribution key by cooperating, in that both partial authorities are able to ensure that they hold parts of the secret key that enables it to be rebuilt.

10. Process in accordance with claim 1 above in which, during the preliminary phase to establish a session key:
The first entity produces a first session key (SKₐ), forms a first cryptogram P_{b}(SKₐ) of this first partial session key (SKₐ) coded by the public key (P_{b}) of the second entity (b), sends this first cryptogram to the second entity (b).
The second entity (b) produces a second partial session key (SK_{b}), forms a second cryptogram Pₐ(SK_{b}) of this first partial session key (SKₐ) coded by the public key (Pₐ) of the first entity (a), and sends this second cryptogram to the first entity (a).
The two entities (b, a) decode the first and second cryptograms with the aid of their secret key (Sₐ, S_{b}), recover the first and second partial session keys (SKₐ, SK_{b}) and form the session key (SK) from the partial session keys.

11. Process in accordance with claim 10 above, in which the entities (a, b) form the session key (SK) through a logical OR exclusive operation between the first and second partial session keys (SKₐ, SK_{b}).

12. Process in accordance with any one of claims 1 to 11, in which the escrow authority (Tₐ, T_{b}) associated with one of the entities (a, b) is the entity user.
